(19) United States
(12) Patent Application Publication
(10) Pub. No.: US 2022/0284441 A1
(43) Pub. Date: Sep. 8, 2022

(54) Detection of Warranty Expiration and Forwarding Notification

(71) Applicant: Capital One Services, LLC, McLean, VA (US)

(72) Inventors: Jonatan Yucra Rodriguez, San Francisco, CA (US); Sahil Verma, San Francisco, CA (US); Han Hai, San Mateo, CA (US)

(21) Appl. No.: 17/189,807

(22) Filed: Mar. 2, 2021

(51) Int. Cl. G06Q 30/00; G06Q 30/06; G06F 16/951; G06Q 20/40

(52) U.S. Cl. CPC G06Q 30/012; G06Q 30/0641; G06F 16/951; G06Q 20/4093

(57) ABSTRACT

Aspects described herein may include detecting, by a browser extension, a checkout page for the purchase of an item using a credit card. Product transaction data and a warranty expiration date of the purchased item may be retrieved, and the warranty expiration date of the purchased item may be stored. Creation of a notification to be sent to the user prior to the warranty expiration may be scheduled. The notification, which includes the warranty expiration date of the purchased item, may then be forwarded to the user through the browser extension.

### FIELD OF USE

Aspects of the disclosure relate generally to retrieving warranty information and providing a notification regarding a product purchased by a user. More specifically, aspects of the disclosure may provide for retrieving warranty expiration data regarding a product purchased by a user and scheduling a notification to be provided to the user prior to the warranty expiration date.

### BACKGROUND

Consumer products typically come with a manufacturer's warranty, and credit card companies often provide extended warranties on consumer products as an added benefit. It may be difficult for the user to keep track of when a warranty claim can be made, as the user may make many different purchases during the year, and the warranty terms may not be prominently displayed to the user when the purchase is made. This ultimately leads to consumer frustration and lost sales.

Aspects described herein may address these and other problems, and generally improve the user's experience with product warranties by providing a notification to the user when a warranty on a product they have purchased is near the expiration date.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Systems as disclosed herein may help users track warranty expiration dates on various items purchased by the user. Aspects described herein may allow for a browser extension to be used to detect when a user purchases an item, and retrieve a warranty expiration date of the item purchased by the user. A notification may be forwarded to the customer when the warranty is soon to expire. A notification of the warranty expiration date may also be sent when it is detected that the user is on a website and conducting a search related to a product previously purchased by the user. Such systems may provide the user with recognition of added benefits available to them from a credit entity that has issued a credit card to the user.

In accordance with other aspects, a computing device may monitor on-line activity of a credit card issued to a user. When a browser extension detects that the user has purchased an item using the credit card, product transaction data regarding the purchased item may be retrieved. A warranty expiration date of the purchased item may also be retrieved by the browser extension, and the product identification code and the warranty expiration date may then be stored. The creation of a notification to be sent to the user may be scheduled to be sent to the user before the warranty expiration date of the purchased item. The notification may be sent to the user through the browser extension while the user is on-line, with the notification including the warranty expiration date of the purchased item.

In accordance with additional aspects, methods as disclosed herein may include monitoring, through a browser extension, on-going on-line activity of the user. After tracking on-line searches by the user related to the purchased item, the browser extension may send the user a supplemental notification forwarding the warranty expiration date of the purchased item.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example of a computing device that may be used in implementing one or more aspects of the disclosure in accordance with one or more illustrative aspects discussed herein;

FIG. 2 shows an example of a web browser displaying a product to be purchased by a user in accordance with one or more aspects of the disclosure.

FIG. 3 shows an example of a web browser displaying a checkout page of a product to be purchased by a user in accordance with one or more aspects of the disclosure.

FIG. 4 shows an example of a web browser displaying a notification being displayed in accordance with one or more aspects of the disclosure.

FIG. 5 shows an example of a web browser displaying a browsing session of a user related to a previously purchased product in accordance with one or more aspects of the disclosure.

FIG. 6 shows an example flow chart for a method of retrieving and storing warranty information regarding a purchased item and sending a notification regarding expiration of a warranty on the purchased item of FIG. 2 according to one or more aspects of the disclosure; and

FIG. 7 shows an example flow chart for a method of monitoring the browsing activity of a user and sending a supplemental notification of the expiration of a warranty according to one or more aspects of the disclosure.

### DETAILED DESCRIPTION

In the following description of the various examples, reference is made to the accompanying drawings, which form a part hereof, and in which is shown by way of illustration various examples in which aspects of the disclosure may be practiced. It is to be understood that other examples may be utilized and structural and functional modifications may be made without departing from the scope of the present disclosure. Aspects of the disclosure are capable of other examples and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for detecting, by a browser extension, when the user has purchased an item using a credit card issued by a credit entity. Warranty expiration data regarding the item purchased by the user may then be retrieved and stored, and a notification may be scheduled to be sent to the user shortly before the warranty expiration date. As discussed further herein, the unconventional combination of steps and/or features may improve the user's experience with warranties, helping ensure that they are notified of warranty expiration dates for products they have purchased prior to the expiration dates, thereby preserving the right of the user to file warranty claims within the warranty window. By providing such notifications, the user can advantageously avoid missing out on the opportunity to file valid warranty claims.

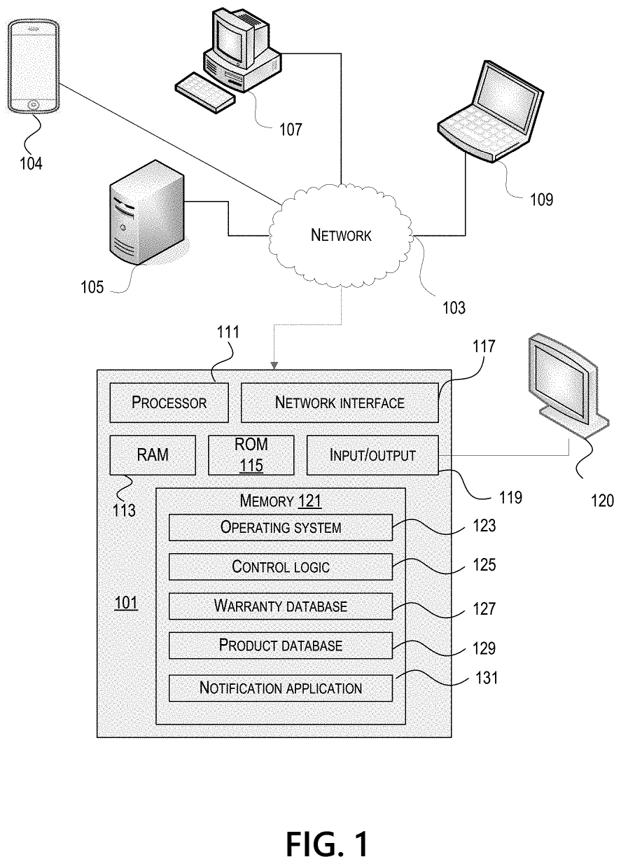

Before discussing these concepts in greater detail, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some examples, implement one or more aspects of the disclosure by reading and/or executing instructions and performing one or more actions based on the instructions. In some examples, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may operate in a standalone environment. In others, computing device 101 may operate in a networked environment. As shown in FIG. 1, various network nodes 101, 104, 105, 107, and 109 may be interconnected via a network 103, such as the Internet. Other networks may also or alternatively be used, including private intranets, corporate networks, local area networks (LANs), wireless networks, personal area networks (PAN), wide area networks (WANs), and the like. Network 103 is for illustration purposes and may be replaced with fewer or additional computer networks. A local area network (LAN) may have one or more of any known LAN topology and may use one or more of a variety of different protocols, such as Ethernet. Devices 101, 104, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Computing device 101 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Processor 111 may comprise a single central processing unit (CPU), which may be a single-core or multi-core processor, or may comprise multiple CPUs. Processor(s) 111 and associated components may allow the computing device 101 to execute a series of computer-readable instructions (e.g., instructions stored in RAM 113, ROM 115, memory 121, and/or other memory of computing device 101, and/or in other memory) to perform some or all of the processes described herein including, for example, the machine learning processes.

Input/output interfaces 119 may include a variety of interface units and/or drivers for reading, writing, displaying, and/or printing data or files. Input/output interfaces 119 may be coupled with a display such as display 120. Input/output interfaces 119 may also comprise a microphone, keypad, touch screen, and/or stylus through which a user of the computing device 101 may provide input, and may also comprise one or more of a speaker for providing audio output and/or a video display device for providing textual, audiovisual, and/or graphical output.

Network interface 117 may comprise one or more transceivers, digital signal processors, and/or additional circuitry and software, protocol stack, and/or network stack for communicating via any network, wired or wireless, using any protocol as described herein.

Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, a warranty database 127, a product database 129, and a notification application 131. The various hardware memory units in memory 121 may comprise volatile and nonvolatile, removable and non-removable media implemented in any method or technology for storage of information such as computer-readable instructions, data structures, program modules, or other data. Memory 121 may comprise one or more physical persistent memory devices and/or one or more non-persistent memory devices. Memory 121 may comprise random access memory (RAM) 113, read only memory (ROM) 115, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 111.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium similar to those discussed above with respect to memory 121. As noted above, the computer readable medium (e.g., memory 121) may comprise a hard disk, optical disk, removable storage media, solid state memory, RAM, etc. As will be appreciated by one of skill in the art, the functionality of the program modules may be combined or distributed as desired in various examples. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

In other examples, computing device 101 may include two or more of any and/or all of these components (e.g., two or more processors, two or more memories, etc.) and/or other components and/or subsystems not illustrated here.

Devices 104, 105, 107, 109 may have similar or different architecture as described with respect to computing device 101. It will appreciate that the functionality of computing device 101 (or devices 104, 105, 107, 109) as described herein may be spread across multiple data processing devices, for example, to distribute processing load across multiple computers, to segregate transactions based on geographic location, user access level, quality of service (QoS), etc. For example, devices 101, 104, 105, 107, 109, and others may operate in concert to provide parallel computing features in support of the operation of control logic 125 and/or notification application 127.

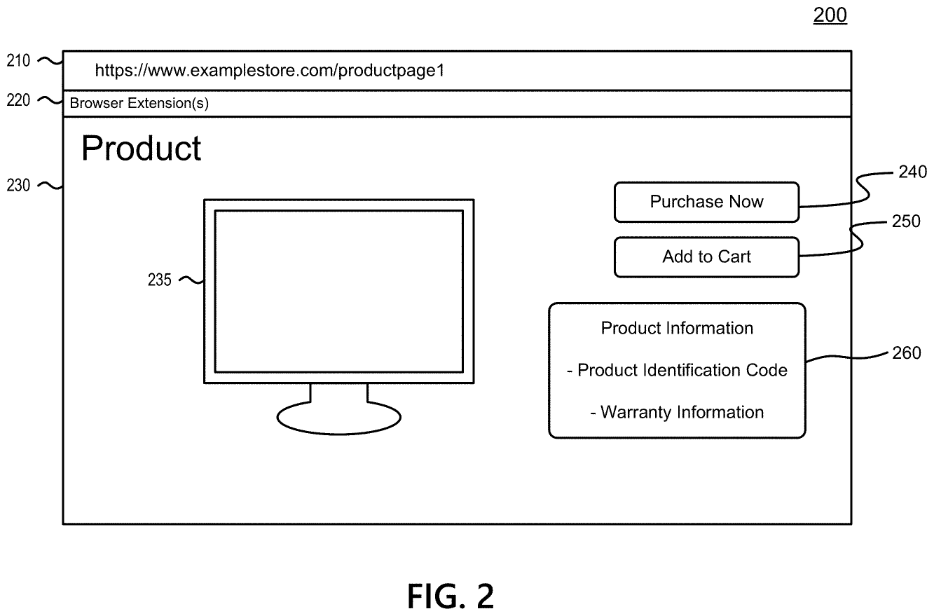

FIG. 2 shows an example of a web browser 200 that may be utilized by a user when purchasing an item on-line in a first browsing session. Web browser 200 may comprise an address field 210, one or more browser extensions 220, and a browser panel 230. The address field 210 may be an address bar. A user may enter (e.g., type) an address (e.g., IP address, uniform resource locator (URL), etc.) in address field 210. The one or more browser extensions 220 may comprise a browser extension to display additional information about a product when the user is shopping. Browser panel 230 may display one or more pages associated with the address entered in address field 210. Browser 200 may display a product page associated with an item to be purchased, such as a monitor 235, for example. The product page displayed in browser panel 230 may include a first button 240 and a second button 250. The first button 240 may allow the user to purchase the product immediately (e.g., “Purchase Now”), while the second button 250 may allow the user to add the product to their shopping cart (e.g., “Add to Cart”) and continue shopping. Browser 200 may also have a display field 260 including product information, such as a product identification code and warranty information.

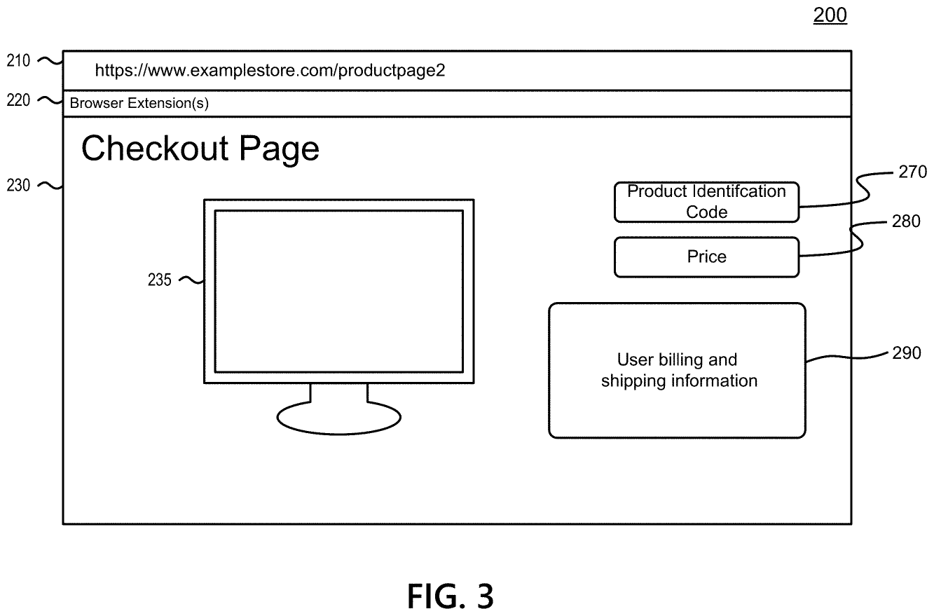

Whether the user purchases the product immediately or adds the product to their cart, the user may ultimately be directed to a checkout page in web browser 200, as illustrated in FIG. 3. The checkout page may display a product identification code field 270, a price field 280, and a purchase field 290 where the user may enter shipping information, e.g., their address, as well as billing information, e.g., their credit card information.

In certain embodiments, the computing device may retrieve product transaction data, such as the product identification code, directly from the vendor of the item. The transaction data may also include basic transaction data such as the vendor's name, the transaction amount, billing zip code, as well as more advanced information including ship-from and ship-to zip codes, invoice and order numbers, item description, and unit of measure, for example. In other embodiments, browser extension 220 may scan the Document Object Model (DOM) of the pages of browser panel 230 in order to obtain the product transaction data.

It is to be appreciated that the user may also purchase an item in a retail establishment using a credit card issued by the credit entity. In such an embodiment, the retail establishment may transmit product transaction data such as the product identification code directly to the computing device 101 of the credit entity.

Once the user has purchased an item, computing device 101 may retrieve warranty information regarding the purchased item. In certain embodiments, product warranty information for a plurality of products may be stored in warranty database 127 of computing device 101. In such embodiments, the credit entity can directly retrieve the warranty information, e.g., the warranty length, from the warranty database and, therefore, can calculate the warranty expiration date for the purchased item using the warranty length the transaction date.

In other embodiments, as illustrated in FIG. 2, the vendor may display warranty information as part of display field 260 when the user is purchasing an item on-line. In such embodiments, browser extension 220 may scan the DOM of the page and determine the product warranty length, and, therefore, be able to calculate the warranty expiration date of the purchased item.

Once the product identification code and warranty expiration date have been retrieved, they can be stored in product database 129 on computing device 101. After the user has purchased an item, and prior to expiration of the warranty period on the purchased item, notification application 131 may be used to schedule the creation of a notification to be sent to the user to let them know that the warranty on the product is set to expire. Such a notification may be sent to the user while the user is on-line in a browsing session, which may be a second browsing session different than the browsing session in which the user purchased the item.

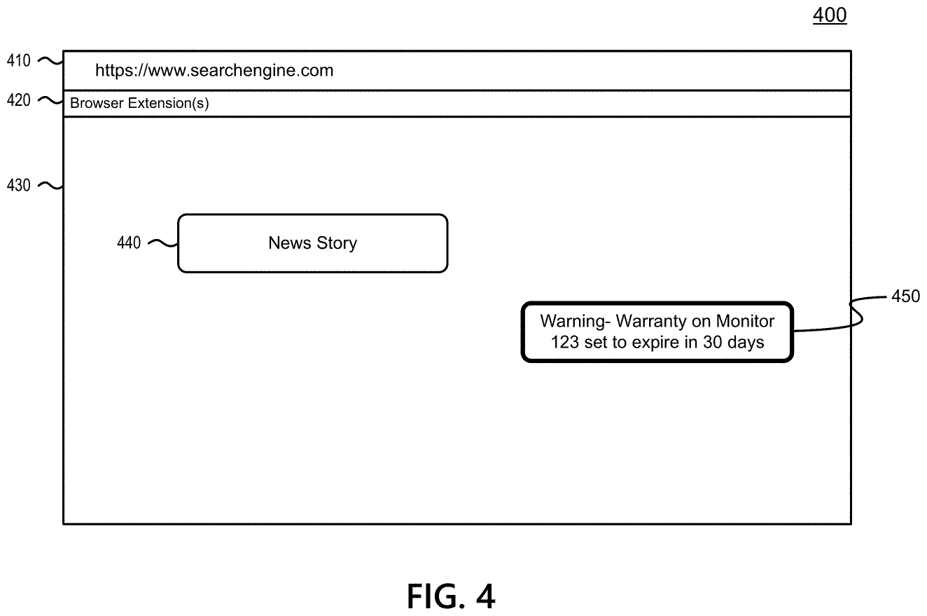

FIG. 4 shows an example of a browser 400 being used by the user in a second browsing session to perform general browsing. Browser 400 may comprise the address field 410, one or more browser extensions 420, and the browser panel 430. Browser panel 430 may display a news story 440 being viewed by the user, for example. While the user is browsing the news story, browser extension 420 may be utilized to display a notification 450 on browser panel 430 indicating to the user that the warranty on an item that they previously purchased with a credit card issued by the credit entity, e.g., the monitor of FIG. 2, is about to expire. For example, notification 450 may indicate to the user that the warranty on the monitor that they purchased is set to expire in 30 days. Such a notification advantageously provides the user with advanced notice so that they may file a warranty claim, giving the user sufficient time to file the warranty claim in the event that they have any type of problem with the purchased item. Providing such notifications can provide marketing benefits to the credit entity, since the notification is an added benefit to purchasing items with the credit card provided by the credit entity.

In certain embodiments, the credit entity may offer an extended warranty to the user for the purchased item, to be purchased by the user, or offered for free by the credit entity as an added benefit. Thus, in certain embodiments, notification 450 may include an offer for the user to buy an extended warranty for the purchased item. In other embodiments, where the extended warranty is provided at no charge by the credit entity, notification 450 may include an additional warning providing the expiration date of the extended warranty provided by the credit entity.

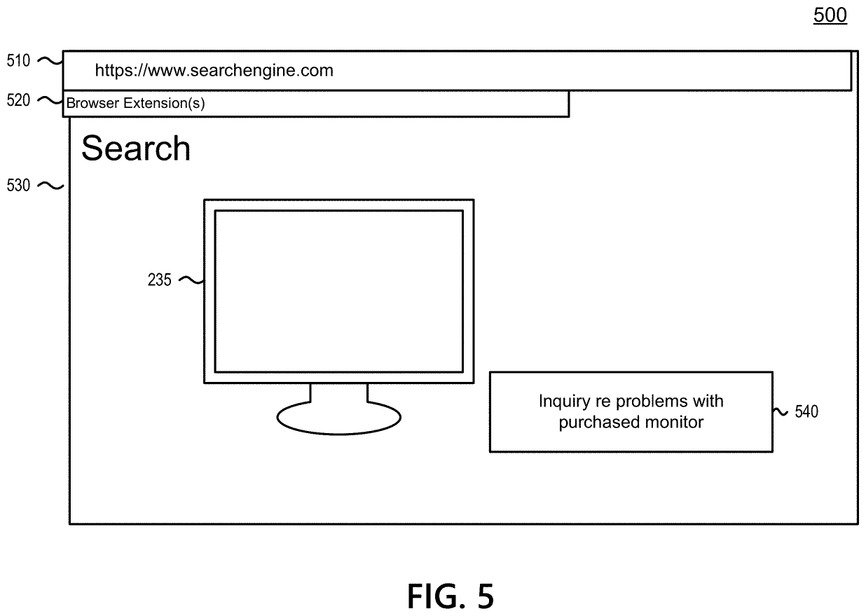

A browser extension may be used to continue to monitor the user's browsing activity to determine if the user has problems or issues with the purchased item, which could prompt computing device 101 to send a supplemental notification to the user to ensure the user is aware of the warranty expiration date of the purchased item. FIG. 5 shows an example of a browser 500 being used by the user to perform a search during a third browsing session. Browser 500 may comprise an address field 510, one or more browser extensions 520, and a browser panel 530. Browser panel 530 may display a search field 540, which the user may use to performing a search related to the purchased monitor 235. Search field 540 may display inquiries related to problems with monitor 235 such as, for example, flickering, vertical lines, random shutoffs, etc. When browser extension 520 detects such inquiries related to problems with the purchased monitor 235, a supplemental notification may be sent to the user providing the warranty expiration date to ensure that the user is aware of that date in the event that they need to file a warranty claim.

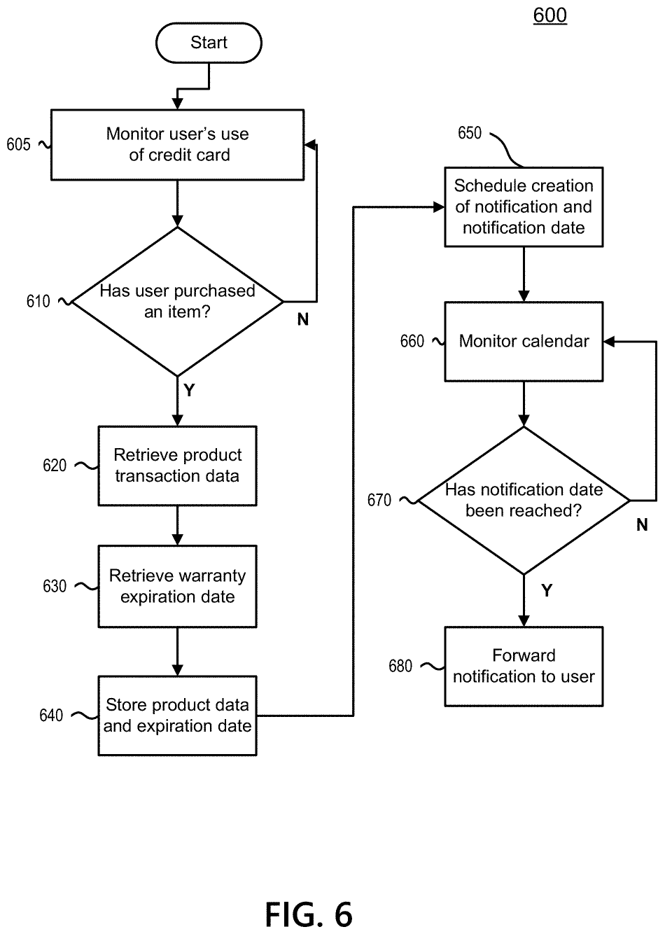

FIG. 6 illustrates an example method 600 for creating and sending a notification in accordance with one or more aspects described herein. As used herein, method 600 may be implemented using a suitable computing system, as described below. For example, method 600 may be implemented by any suitable computing environment by a computing device and/or combination of computing devices, such as computing devices 101, 104, 105, 107, and 109 of FIG. 1. Method 600 may be implemented in suitable program instructions and may operate using any combination of computing devices.

At step 605, the use of a credit card issued to the user by the credit entity may be monitored for purchasing activity. In certain embodiments, the credit entity may monitor the use of the credit card in retail establishments. In other embodiments, the browser extension may monitor the use of the credit card on-line during on-line activity in a browsing session. In further embodiments, the credit card entity may monitor the use of the credit card in both retail establishments and on-line simultaneously.

At step 610, the on-line activity of the user may be monitored to detect when a user has purchased an item. In embodiments where the user has purchased an item at a retail establishment, a computing device 104, 105, 107, or 109 of the retail establishment may transmit to computing device 101 of the credit entity sales information regarding a purchase of an item by the user using the credit card issued to the user by the credit entity. In embodiments where the user purchases the item on-line, the browser extension may detect that a user has submitted a checkout page for a transaction using the credit card issued to the user by the credit entity.

If at step 610 the browser extension 220 of FIG. 3 has not detected that a user has purchased an item, browser extension 220 may continue to monitor the use of a credit card issued to the user at step 605. If at step 610 browser extension 220 detects that the user has purchased an item, such as by browser extension 220 detecting that the user has submitted a checkout page for the item using a credit card, the browser extension at step 620 may retrieve product transaction data, which may include a product identification code and a transaction date.

At step 620, in embodiments where the item is purchased by the user at a retail establishment, the computing device 104, 105, 107, or 109 of the retail establishment may transmit product transaction data to computing device 101, such as a product identification code and a transaction date.

At step 630, warranty data regarding the item purchased by the user may be retrieved, including a warranty expiration date. In certain embodiments, to retrieve the warranty data, warranty database 127 on computing device 101 may be accessed in order to obtain warranty information, including warranty expiration dates, for a plurality of products.

In other embodiments, when a user has purchased the item on-line, the browser extension may read the DOM of the website being accessed by the user during the purchase of the item, and pull the warranty data provided on the website by the on-line vendor.

At step 640, the product identification code and warranty information may be stored, including the warranty expiration date, in product database 129 on computing device 101.

At step 650, notification application 131 on computing device 101 may be utilized to schedule the creation of a notification to be sent to the user on a notification date that is prior to the warranty expiration date. In certain embodiments, the notification may be scheduled to be sent to the user a pre-determined number of days before the warranty expiration date.

At step 660, the notification application may be utilized to monitor a calendar in order to determine if the notification date has been reached. At step 370, the notification application evaluates whether the notification date has been reached. If, at step 370, the notification date has not been reached, the notification application continues to monitor the calendar at step 360. If, at step 370, the notification date has been reached, then the notification application may forward notification 450 to the user at step 680.

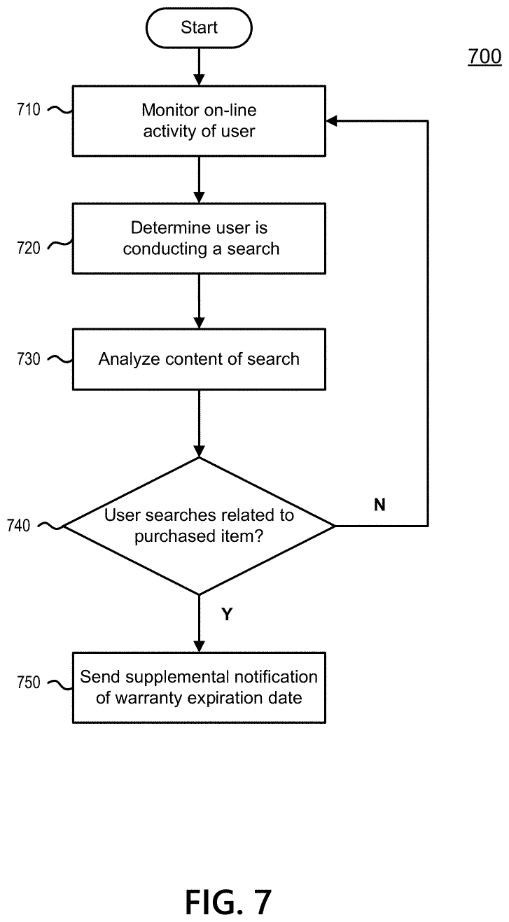

FIG. 7 illustrates an example method 700 for monitoring the user's on-going browsing activity after purchase of the item in accordance with one or more aspects described herein. As used herein, method 700 may be implemented using a suitable computing system, as described below. For example, method 700 may be implemented by any suitable computing environment by a computing device and/or combination of computing devices, such as computing devices 101, 104, 105, 107, and 109 of FIG. 1. Method 700 may be implemented in suitable program instructions and may operate using any combination of computing devices.

At step 710, the browser extension 520 of FIG. 5 may monitor the on-line activity of the user. At step 720, the browser extension may determine that a user is conducting a search, and at step 730 the browser extension may analyze the content of the search parameters. At step 740, the browser extension may evaluate whether the search parameters are related to a product purchased by the user using a credit card issued by the credit entity.

If, at step 740, the browser extension determines that the search conducted by the user is not related to a product purchased by the user using a credit card issued by the credit entity, the browser extension may continue to monitor the on-line activity of the user at step 710. If, at step 740, the browser extension determines that the search conducted by the user is related to a product purchased by the user using a credit card issued by the credit entity, a supplemental notification may be sent to the user that includes the warranty expiration date for the purchased product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A computer-implemented method comprising:
detecting, through a browser extension on a user's computer during a first browsing session, that the user has submitted a checkout page for a transaction using a credit card;
retrieving, by the browser extension, product transaction data regarding an item purchased by the user with the credit card during the transaction, the product transaction data including a product identification code and a transaction date,
retrieving, by the browser extension, a warranty expiration date of the purchased item based on the transaction date;
storing the product identification code of the item purchased by the user during the browsing session and the warranty expiration date of the item purchased by the user;
scheduling creation of a notification to be sent to the user on a notification date that is a pre-determined number of days before the warranty expiration date of the purchased item; and
forwarding to the user on or after the notification date, the notification through the browser extension during a second browsing session, the notification including the warranty expiration date of the purchased item.

2. The computer-implemented method of claim 1, further comprising the step of retrieving product transaction data regarding the purchased item from a vendor selling the purchased item to the user, the transaction data including the product identification code and a warranty length.

3. The computer-implemented method of claim 1, wherein the browser extension scans a Document Object Model of a web page displaying the purchased item to obtain the warranty expiration date.

4. The computer-implemented method of claim 1, further comprising the step of accessing a database of warranty expiration data to obtain a warranty length for the item purchased by the user.

5. The computer-implemented method of claim 1, wherein the step of retrieving the warranty expiration date includes the browser extension conducting a search of web pages in the first browsing session.

6. The computer-implemented method of claim 1, wherein the notification includes the warranty expiration date of the purchased item, and an additional warranty expiration date regarding an extended warranty provided to the user.

7. The computer-implemented method of claim 1, wherein the notification includes an offer for the user to purchase an extended warranty on the purchased item before the warranty expiration date of the purchased item.

8. The computer-implemented method of claim 1, further comprising the steps of:
monitoring, through the browser extension, on-line activity of the user in a third browsing session;
tracking, by the browser extension, searches by the user related to the purchased item; and
sending, to the user through the browser extension during the second browsing session, a supplemental notification forwarding the warranty expiration date of the purchased item.

9. The computer-implemented method of claim 1, wherein the step of retrieving product transaction data is performed at a time of purchase.

10. A computing device, comprising:
at least one processor;
a non-transitory computer-readable medium comprising computer-executable instructions that, when executed by the at least one processor, cause the computing device to:
monitor, with a browser extension, on-line activity of a credit card issued to a user;
detect, by the browser extension; that the user has purchased an item using the credit card;
retrieve, by the browser extension, product transaction data regarding the item purchased by the user with the credit card, the product transaction data including a product identification code;
retrieve, by the browser extension, a warranty expiration date of the purchased item;
store the product identification code and the warranty expiration date of the purchased item;
schedule creation of a notification to be sent to the user on a notification date that is a pre-determined number of days before the warranty expiration date of the purchased item; and
forward to the user on or after the notification date, the notification through the browser extension while the user is on-line, the notification including the warranty expiration date of the purchased item.

11. The computing device of claim 10, wherein the instructions cause the computing device to retrieve data regarding the purchased item from a vendor selling the purchased item to the user.

12. The computing device of claim 10, wherein the instructions cause the computing device to retrieve the product transaction data by scanning a Document Object Model of a web page with the browser extension.

13. The computing device of claim 10, wherein the instructions cause the computing device to access a database of warranty expiration data to obtain the warranty expiration date of the purchased item.

14. The computing device of claim 10, wherein the notification includes the warranty expiration date of the purchased item, and an additional warranty expiration date regarding an extended warranty provided to the user.

15. The computing device of claim 10, wherein the notification includes an offer for the user to purchase an extended warranty on the purchased item before the warranty expiration date of the purchased item.

16. The computing device of claim 10, wherein the instructions cause the computing device to:
monitor, by the browser extension, on-going on-line activity of the user;
track, by the browser extension, searches by the user related to the purchased item; and
send, to the user through the browser extension while the user is on-line, a supplemental notification forwarding the warranty expiration date of the purchased item.

17. A non-transitory computer-readable medium comprising computer-executable instructions that when executed by a processor, cause a computing device to:
monitor, by a browser extension, on-line activity of a credit card issued to a user by a credit entity;
retrieve, by the browser extension, product transaction data regarding an item purchased on-line by the user with the credit card, the product transaction data including a product identification code;
retrieve, by the browser extension, a warranty expiration date of the purchased item;
store the product identification code and the warranty expiration date of the purchased item;
schedule creation of a notification to be sent to the user on a notification date that is a pre-determined number of days before the warranty expiration date of the purchased item;
forward the notification through the browser extension while the user is on-line, the notification including the warranty expiration date of the purchased item;
monitor, by the browser extension, on-going on-line activity of the user;
track, by the browser extension, on-line searches by the user related to the purchased item; and
send, to the user through the browser extension while the user is on-line, a supplemental notification forwarding the warranty expiration date of the purchased item.

18. The non-transitory computer-readable medium of claim 17, wherein the notification includes the warranty expiration date of the purchased item, and an additional warranty expiration date regarding an extended warranty provided by the credit entity.

19. The non-transitory computer-readable medium of claim 17, wherein the notification includes an offer for the user to purchase an extended warranty on the purchased item before the warranty expiration date of the purchased item.

20. The non-transitory computer-readable medium of claim 17, wherein the instructions cause the computing device to retrieve the product transaction data by scanning a Document Object Model of a web page with the browser extension.
